(19) United States
(12) Patent Application Publication
(10) Pub. No.: US 2026/0222664 A1
(43) Pub. Date: Jul. 30, 2026

(54) IMAGING DEVICE

(71) Applicant: SONY GROUP CORPORATION, TOKYO (JP)

(72) Inventors: ILYA RESHETOUSKI, KANAGAWA (JP); HIDEKI OYAIZU, KANAGAWA (JP)

(21) Appl. No.: 19/150,991

(22) PCT Filed: Jan. 22, 2024
(86) PCT No.: PCT/JP2024/001639

§ 371 Date: Jul. 25, 2025

(30) Foreign Application Priority Data
Feb. 6, 2023 (JP) 2023-015870

(51) Int. Cl. H04N 23/55; H04N 23/955

(52) U.S. Cl. CPC H04N 23/55; H04N 23/955

(57) ABSTRACT

The present disclosure relates to an imaging device capable of reducing a mask of a lensless camera. The mask modulates the incident light to convert the incident light into modulated light, the imaging element captures a modulated image including the modulated light, and the reconstruction unit reconstructs an image corresponding to the incident light on the basis of the modulated image. At this time, the mask condenses the incident light transmitted through the transmission region and changes the optical path of the condensed incident light to realize the point spread function same as the reference mask realized by two-dimensionally arranging the transmission region that transmits the incident light and the light shielding region that shields the incident light. The present disclosure can be applied to a lensless camera.

### TECHNICAL FIELD

The present disclosure relates to an imaging device, and more particularly, to an imaging device in which a device configuration is downsized without deteriorating image quality of an original image to be reconstructed in a lensless camera.

### BACKGROUND ART

A technology of a lensless camera in which a mask provided with a two-dimensional pattern including a transmission region and a non-transmission region (light shielding region) is arranged at a preceding stage of an imaging element, and an original image to be a scene is reconstructed from a modulated image including an observation value projected onto the imaging element through the mask has been widely used.

With regard to this lensless camera technology, there has been proposed a technology for improving image quality of an original image to be reconstructed by using a uniformly redundant array (URA) pattern mask as a mask pattern (See Patent Document 1).

In addition, there has been proposed a technique of improving distortion of a point spread function (PSF) caused by incident light incident from an oblique direction over a wide range and improving image quality of a reconstructed original image by mounting a Fresnel zone plate (FZP) in a transmission region of a mask (See Patent Document 2 and Non-Patent Document 1).

### CITATION LIST

### Patent Document

Patent Document 1: WO 2021/111888 A
Patent Document 2: U.S. Pat. No. 4,360,797

### Non-Patent Document

Non-Patent Document 1: Migration from Diffractive to Refractive Mask for High Quality Lensless Imaging. COSI 2022.

### SUMMARY OF THE INVENTION

### Problems to be Solved by the Invention

Meanwhile, in a lensless camera, in general, the size of a mask is required to be at least twice or more the size of an imaging element, and this point is similar in any of the techniques of Patent Documents 1 and 2 and Non-Patent Document 1.

One of the advantages of the lensless camera is that the lens can be eliminated from the device configuration, so that downsizing and height reduction of the device configuration are realized.

However, since the size of the mask is required to be at least twice the size of the imaging element as described above, this is a limitation of downsizing of the device configuration.

If the size of the mask is simply reduced, the image quality of the original image to be reconstructed may be deteriorated.

The present disclosure has been made in view of such a situation, and in particular, in a lensless camera, downsizing of a device configuration is realized without deteriorating image quality of an original image to be reconstructed.

### Solutions to Problems

An imaging device according to one aspect of the present disclosure is an imaging device including: a modulation mask that modulates incident light to convert the incident light into modulated light; an imaging element that captures a modulated image including the modulated light transmitted through the modulation mask; and a reconstruction unit that reconstructs an image corresponding to the incident light on the basis of the modulated image, in which the modulation mask condenses the incident light to realize a point spread function same as a reference mask realized by two-dimensionally arranging a transmission region that transmits the incident light and a light shielding region that shields the incident light, and changes and modulates an optical path.

In one aspect of the present disclosure, incident light is modulated and converted into modulated light by a modulation mask, a modulated image including the modulated light transmitted through the modulation mask is captured by an imaging element, an image corresponding to the incident light is reconstructed on the basis of the modulated image by a reconstruction unit, the incident light is condensed by the modulation mask to realize a point spread function same as a reference mask realized by two-dimensionally arranging a transmission region that transmits the incident light and a light shielding region that shields the incident light, and an optical path is changed and modulated.

### BRIEF DESCRIPTION OF DRAWINGS

FIG. 1 is a diagram for explaining an overview of a lensless camera.

FIG. 2 is a diagram for explaining an imaging principle of a lensless camera.

FIG. 3 is a diagram for explaining arithmetic processing by lensless imaging processing.

FIG. 4 is a diagram for explaining a relationship between an incident angle of incident light and a point spread function.

FIG. 5 is a diagram for explaining a relationship between an incident angle of incident light and a point spread function.

FIG. 6 is a diagram for explaining a relationship between an incident angle of incident light and a point spread function.

FIG. 7 is a diagram for explaining a relationship between an incident angle of incident light and a point spread function.

FIG. 8 is a diagram for explaining an overview of a mask of the present disclosure.

FIG. 9 is a diagram for explaining a configuration example of an imaging device of the present disclosure.

FIG. 10 is a diagram for explaining a configuration example of the mask of FIG. 9.

FIG. 11 is a diagram for explaining a configuration example of an optical path light condensing changing unit in FIG. 10.

FIG. 12 is a diagram for explaining a simulation example of the mask of FIG. 9.

FIG. 13 is a diagram for explaining a point spread function by the mask of FIG. 9.

FIG. 14 is a diagram for explaining another configuration example of the optical path light condensing changing unit in FIG. 10.

FIG. 15 is a diagram for explaining a configuration example of a mask using the optical path light condensing changing unit in FIG. 14.

FIG. 16 is a diagram for explaining a point spread function in a conventional mask.

FIG. 17 is a diagram for explaining a point spread function in the mask of the present disclosure.

FIG. 18 is a diagram for explaining a simulation example of a mask of the present disclosure.

FIG. 19 is a diagram for explaining a comparison between a simulation example of a mask of the present disclosure and a simulation example of a conventional mask.

FIG. 20 is a diagram for explaining the principle of general depth measurement.

FIG. 21 is a diagram for explaining the principle of general depth measurement.

FIG. 22 is a configuration example of a depth measurement device to which the mask of the present disclosure is applied.

### MODE FOR CARRYING OUT THE INVENTION

Hereinafter, preferred embodiments of the present disclosure will be described in detail with reference to the accompanying drawings. Note that, in the present specification and the drawings, components having substantially the same functional configuration are denoted by the same reference signs, and redundant description is omitted.

Hereinafter, modes for carrying out the present technology will be described. The description will be given in the following order.
1. Overview of Lensless Imaging Device
2. Preferred Embodiment
3. Application Example

### 1. Overview of Lensless Imaging Device

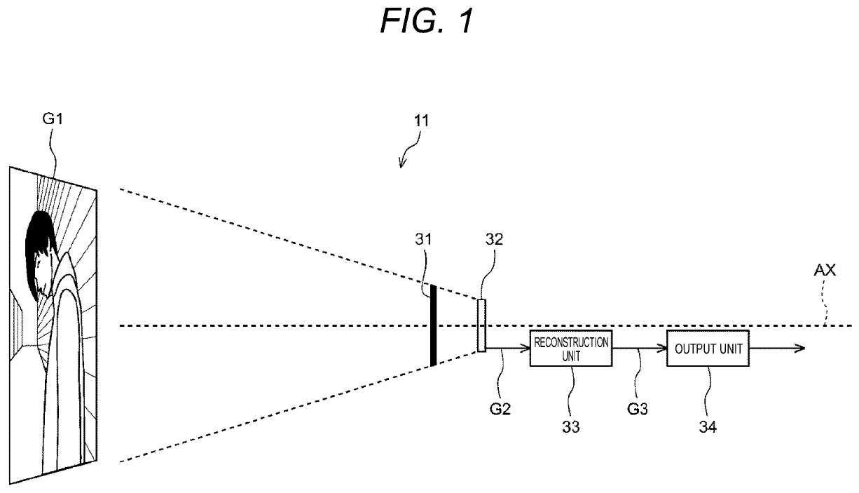

An overview of a lensless imaging device will be described with reference to FIG. 1. Note that FIG. 1 is a side cross-sectional view of an imaging device 11.

The imaging device 11 in FIG. 1 is a so-called lensless camera, and includes a mask 31, an imaging element 32, a reconstruction unit 33, and an output unit 34.

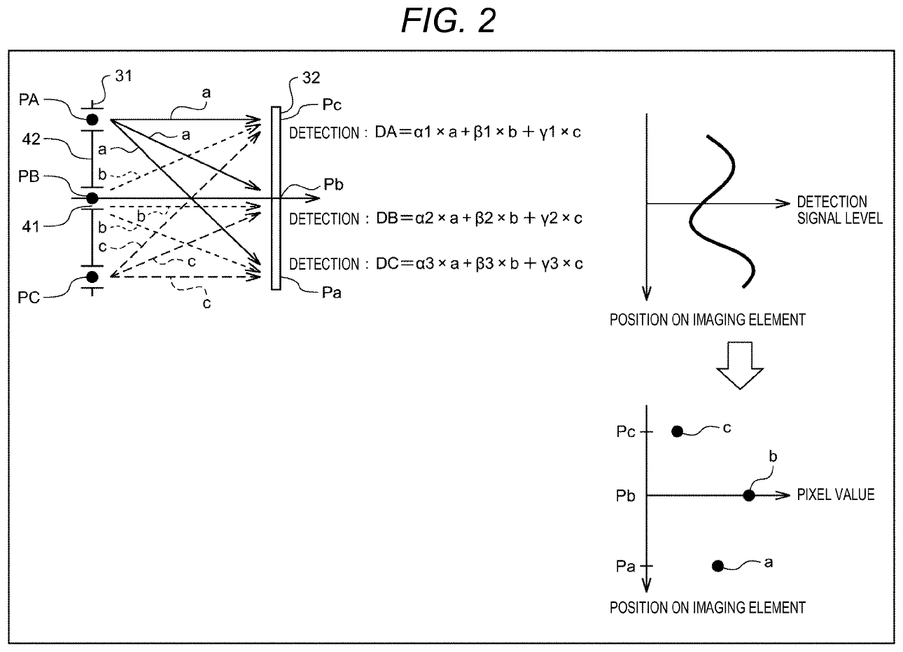

The mask 31 has a plate-like configuration constituted by a light shielding material provided in the preceding stage of the imaging element 32, and for example, as illustrated in the left part of FIG. 2, includes a transmission region 41 including a hole-shaped opening that transmits incident light, and a light shielding region 42 that is shielded from light other than the transmission region 41.

When the mask 31 receives light from a subject surface (a surface on which radiation light from a three-dimensional subject is actually emitted) G1 indicated by the optical axis AX as incident light, the mask transmits the incident light through the transmission region 41 to modulate the incident light from the subject surface G1 as a whole and convert the incident light into modulated light, and causes the imaging element 32 to receive and image the converted modulated light.

The imaging element 32 includes a complementary metal oxide semiconductor (CMOS) image sensor or a charge coupled device (CCD) image sensor, captures an image of modulated light obtained by modulating incident light from the subject surface G1 by the mask 31, and outputs the captured modulated light to the reconstruction unit 33 as a modulated signal G2 including signals on a pixel basis. More specifically, the imaging element 32 includes a signal processing unit (not illustrated), generates RAW data on the basis of an image including the modulated signal G2, and outputs the RAW data to the reconstruction unit 33.

Note that the mask 31 has a size that covers at least the entire surface of the imaging element 32, and basically, in the imaging element 32, only modulated light modulated by being transmitted through the mask 31 is received.

Furthermore, the transmission region 41 formed in the mask 31 has a size larger than at least the pixel size of the imaging element 32. Furthermore, a gap having a minute distance d is provided between the imaging element 32 and the mask 31.

For example, as illustrated in the upper left part of FIG. 2, it is assumed that incident light from the point light sources PA, PB, and PC on the subject surface G1 is transmitted through the transmission region 41 of the mask 31 and received as light beams of light intensities a, b, and c at positions Pa, Pb, and Pc on the imaging element 32, respectively.

As illustrated in the upper left part of FIG. 2, the detection sensitivity of each pixel has directivity according to the incident angle as the incident light is modulated by the transmission region 41 set in the mask 31. Providing the detection sensitivity of each pixel with the incident angle directivity here means providing the light receiving sensitivity characteristic according to the incident angle of the incident light so as to be different according to the region on the imaging element 32.

That is, in a case where it is assumed that the light source constituting the subject surface G1 is a point light source, in the imaging element 32, light beams having the same light intensity emitted from the same point light source are incident, but the incident angle changes for each region on the imaging surface of the imaging element 32 by being modulated by the mask 31. Then, since the mask 31 changes the incident angle of the incident light according to the region on the imaging element 32 to have the light receiving sensitivity characteristic, that is, the incident angle directivity, even light beams having the same light intensity are detected with different sensitivities for each region on the imaging element 32 by the mask 31 provided in the preceding stage of the imaging surface of the imaging element 32, and detection signals having different detection signal levels for each region are detected.

More specifically, as illustrated in the upper right part of FIG. 2, the detection signal levels DA, DB, and DC of the pixels at the positions Pa, Pb, and Pc on the imaging element 32 are expressed by the following Formulas (1) to (3), respectively. Note that, in Formulas (1) to (3) in FIG. 2, the vertical relationship is inverted from the positions Pa, Pb, and Pc on the imaging element 32 in FIG. 2.

$$DA = α1 \times a + β1 \times b + γ1 \times c \qquad ( 1 )$$

$$DB = α2 \times a + β2 \times b + γ2 \times c \qquad ( 2 )$$

$$DC = α3 \times a + β3 \times b + γ3 \times c \qquad ( 3 )$$

Here, α1 is a coefficient for the detection signal level a set according to the incident angle of the light beam from the point light source PA on the subject surface G1 to be restored at the position Pa on the imaging element 32.

Furthermore, β1 is a coefficient for the detection signal level b set according to the incident angle of the light beam from the point light source PB on the subject surface G1 to be restored at the position Pa on the imaging element 32.

Furthermore, γ1 is a coefficient with respect to the detection signal level c set according to the incident angle of the light beam from the point light source PC on the subject surface G1 to be restored at the position Pa on the imaging element 32.

Therefore, (α1×a) of the detection signal levels DA indicates the detection signal level by the light beam from the point light source PA at the position Pa.

In addition, (β1×b) of the detection signal levels DA indicates the detection signal level by the light beam from the point light source PB at the position Pa.

Furthermore, (γ1×c) of the detection signal levels DA indicates the detection signal level by the light beam from the point light source PC at the position Pa.

Therefore, the detection signal level DA is expressed as a composite value of components of the point light sources PA, PB, and PC at the position Pa multiplied by the coefficients α1, β1, and γ1. Hereinafter, the coefficients α1, β1, and γ1 are collectively referred to as a coefficient set.

Similarly, for the detection signal level DB in the point light source Pb, the coefficient sets α2, β2, and γ2 respectively correspond to the coefficient sets α1, β1, and γ1 for the detection signal level DA in the point light source PA. In addition, for the detection signal level DC in the point light source Pc, the coefficient sets α3, β3, and γ3 respectively correspond to the coefficient sets α1, β1, and γ1 for the detection signal level DA in the point light source Pa.

However, the detection signal levels of the pixels at the positions Pa, Pb, and Pc are values expressed by the sum of products of the light intensities a, b, and c of the light beams emitted from the point light sources PA, PB, and PC, respectively, and the coefficients. Therefore, since the light intensities a, b, and c of the light beams emitted from the point light sources PA, PB, and PC are mixed, the detection signal levels are different from those at which the image of the subject is formed. Note that an image including the detection signal levels DA, DB, and DC of the pixels at the positions Pa, Pb, and Pc corresponds to the modulated signal G2 in FIG. 1.

That is, by forming simultaneous equations using the coefficient sets α1, β1, and γ1, the coefficient sets α2, β2, and γ2, the coefficient sets α3, β3, and γ3, and the detection signal levels DA, DB, and DC, and solving the light intensities a, b, and c, the pixel values at the respective positions Pa, Pb, and Pc are obtained as illustrated in the lower right part of FIG. 2. As a result, the restored image (final image) that is a set of pixel values is reconstructed and restored. Note that the reconstructed image corresponds to the image G3 in FIG. 1.

Furthermore, in a case where the distance between the imaging element 32 and the subject surface G1 illustrated in the upper left part of FIG. 2 changes, the coefficient sets α1, β1, and γ1, the coefficient sets α2, β2, and γ2, and the coefficient sets α3, β3, and γ3 change, respectively. However, by changing these coefficient sets, restored images (final images) of the subject surfaces at various distances can be reconstructed.

Therefore, by changing the coefficient set to those corresponding to various distances by one imaging, images of the subject surface at various distances from the imaging position can be reconstructed.

As a result, in the imaging using the imaging device 11 in FIG. 1, it is not necessary to be aware of a phenomenon such as so-called defocusing that is imaging in a state where the focal point is shifted in the imaging by the imaging device using the lens, and if imaging is performed so that a subject to be imaged is included in the field of view, it is possible to reconstruct images of subject surfaces at various distances after imaging by changing the coefficient set according to the distance.

Note that, since the detection signal level illustrated in the upper right part of FIG. 2 is not the detection signal level corresponding to the image on which the image of the subject is formed, the detection signal level is not a pixel value but a simple observation value, and the image including the observation value corresponds to the modulated signal G2. Furthermore, the detection signal level illustrated in the lower right part of FIG. 2 is a signal value for each pixel corresponding to the image on which the image of the subject is formed, that is, a value of each pixel of the restored image (final image) restored on the basis of the modulated signal G2, and thus, is a pixel value. That is, the restored image (final image) of the subject surface G1 corresponds to the image G3.

With such a configuration, the imaging device 11 can function as a so-called lensless camera. As a result, since the imaging lens is not an essential component, it is possible to reduce the height of the imaging device, that is, to reduce the thickness with respect to the incident direction of light in the configuration that realizes the imaging function. Furthermore, by variously changing the coefficient set, it is possible to reconstruct and restore the final image (restored image) on the subject surface at various distances.

Note that, hereinafter, an image corresponding to the modulated signal G2 before being reconstructed captured by the imaging element 32 is simply referred to as a modulated image, and an image corresponding to the image G3 reconstructed and restored by performing signal processing on the modulated image is referred to as a final image (restored image). Therefore, from one modulated image, images on the subject surface G1 at various distances can be reconstructed as a final image by variously changing the coefficient set described above.

The reconstruction unit 33 includes the above-described coefficient set, and reconstructs the final image (restored image) (image G3 in FIG. 1) on the basis of the captured modulated image (modulated signal G2 in FIG. 1) including the RAW data supplied from the imaging element 32 using the coefficient set according to the distance from the imaging position of the imaging device 11 to the subject surface G1, and outputs the final image (restored image) to the output unit 34.

The output unit 34 performs signal processing on the final image supplied from the reconstruction unit 33 and outputs the final image as an image signal.

### <Relationship Between Mask and Imaging Element>

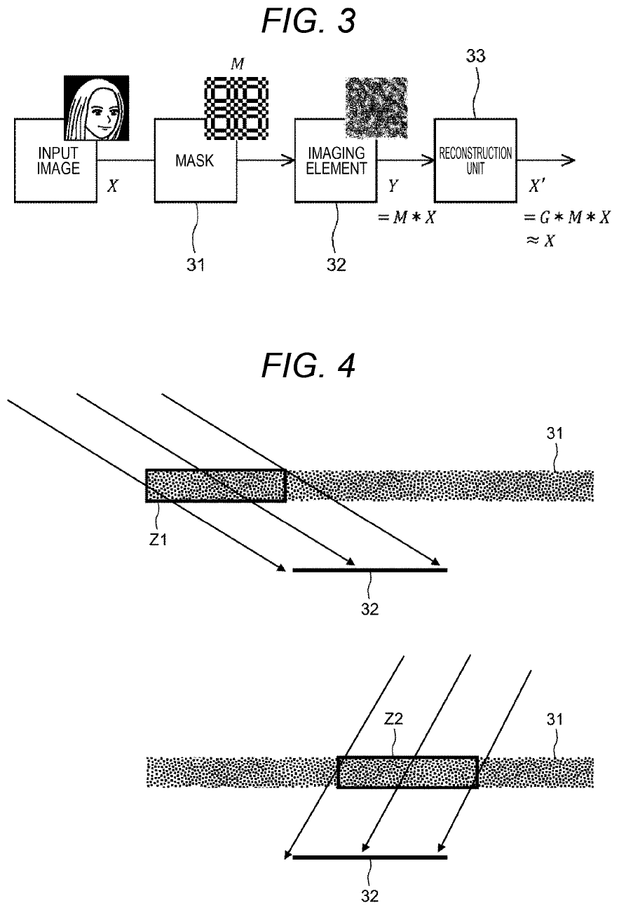

A series of processing of the imaging device 11 realized by the above-described principle is summarized as processing illustrated in FIG. 3.

That is, when incident light including the input image X corresponding to the subject surface G1 in FIG. 1 is incident on the mask 31, modulation by the pattern A of the mask 31 is applied, and imaging is performed by the imaging element 32.

The imaging element 32 captures incident light, which is modulated by the pattern A of the mask 31 on the input image X corresponding to the subject surface G1, as a modulated image Y corresponding to the modulated signal G2 in FIG. 1, and outputs the modulated image Y to the reconstruction unit 33.

The reconstruction unit 33 reconstructs a final image X′ corresponding to the input image X, which corresponds to the final image G3 in FIG. 1, by performing signal processing on the modulated image Y.

It is known that, in the series of processing of the imaging device 11, the modulated image Y corresponding to the modulated signal G2 imaged by the imaging element 32 can be expressed as a convolution of the pattern A of the mask 31 and the input image X as expressed by the following Formula (4).

$$Y = A * X \qquad ( 4 )$$

Here, as illustrated in FIG. 3, Y is a modulated image captured by the imaging element 32, A is a matrix expressing the pattern of the mask 31, X is an input image, and * represents a convolution operation.

As the pattern of the mask 31 expressed as the matrix A, for example, a uniformly redundant arrays (URA) pattern or a modified URA (MURA) pattern is generally used.

It is known that the autocorrelation function of the URA pattern and the MURA pattern is a δ function, and when this feature is utilized, image reconstruction processing can be performed by convolution as expressed by the following Formula (5), and calculation can be performed in a lightweight manner by fast Fourier transform (FFT).

$${X}^{′} = G * A * X = {F}^{- 1} ( F ( G ) \cdot F ( A * X ) ) \qquad ( 5 )$$

Here, X′ represents a reconstructed image corresponding to the reconstructed image G3 in FIG. 1, and G represents a restoration matrix (inverse matrix of A) corresponding to the matrix of the pattern A of the mask 31.

### <Relationship Between Incident Angle of Incident Light and Point Spread Function>

Next, the relationship between the incident angle of the incident light transmitted through the mask 31 and the point spread function on the surface on which the imaging element 32 is provided will be described.

As illustrated in the upper and lower parts of FIG. 4, a configuration in which the mask 31 and the imaging element 32 are provided from the upper side in the drawing, and incident light enters from the upper side to the lower side in the drawing will be considered.

For example, as illustrated in the upper part of FIG. 4, incident light incident obliquely from the upper left to the lower right in the drawing at a relatively large incident angle is modulated by being transmitted through a range Z1 near the left end portion of the mask 31 in the drawing, and the modulation result is imaged in the imaging element 32 as a modulated image.

On the other hand, as illustrated in the lower part of FIG. 4, incident light incident at a relatively small incident angle in an oblique direction from the upper right to the lower left in the drawing is modulated by being transmitted through a range Z2 slightly rightward from the center of the mask 31, and the modulation result is imaged in the imaging element 32 as a modulated image.

As described above, the incident light is modulated in a region near the center of the mask 31 as the incident angle is smaller and the incident light is incident from a direction closer to perpendicular to the mask 31, and a modulated image as a modulation result is captured in the imaging element 32.

Conversely, as the incident angle increases, the incident light is modulated in a region of an end portion away from the center of the mask 31, and a modulated image as a modulation result is captured by the imaging element 32.

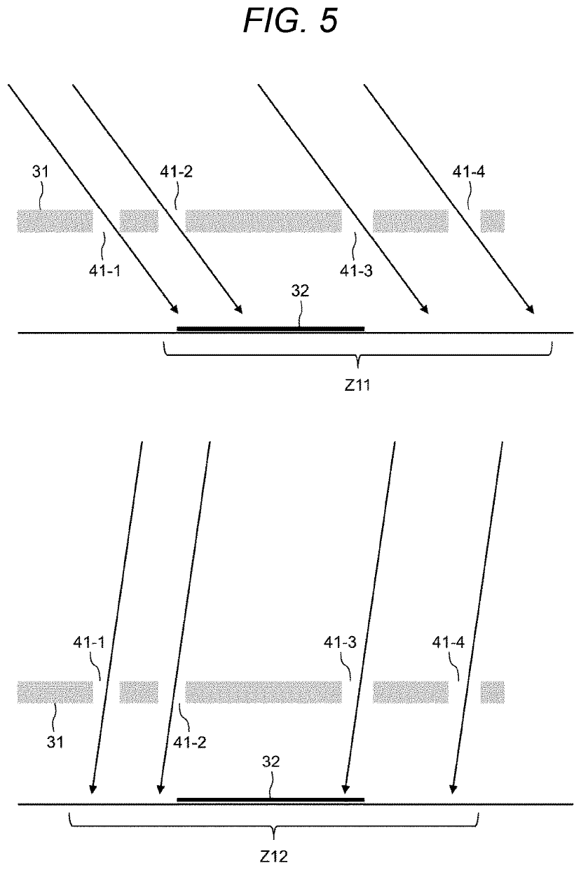

In addition, the point spread function (PSF) generated when the incident light is transmitted through the entire mask 31 has a relationship as illustrated in FIG. 5.

That is, as illustrated in the upper part of FIG. 5, in a case where the transmission regions 41-1 to 41-4 are formed in the mask 31, incident light incident at a relatively large incident angle in an oblique direction from the upper left to the lower right is modulated by being transmitted through the entire mask 31, and a point spread function (PSF) is formed in a range Z11 in the drawing on the plane on which the imaging element 32 is formed.

Here, the upper part of FIG. 5 illustrates that, among the incident light incident obliquely from the upper left to the lower right, the incident light transmitted through the transmission regions 41-1 and 41-2 arranged at positions close to the left end portion in the drawing in the mask 31 is incident on the imaging element 32.

Furthermore, as illustrated in the upper part of FIG. 5, the incident light incident obliquely from the upper left to the lower right at a relatively large incident angle is modulated by the mask 31, whereby a point spread function (PSF) is formed at a position offset in the right direction in the drawing with respect to the position of the imaging element 32 as indicated by the range Z11.

On the other hand, as illustrated in the lower part of FIG. 5, incident light incident obliquely from the upper right to the lower left in the drawing at a relatively small incident angle is transmitted through the entire mask 31 to be modulated, and a point spread function (PSF) is formed in a range Z12 on the surface on which the imaging element 32 is formed.

The lower part of FIG. 5 illustrates that, among the incident light incident obliquely from the upper right to the lower left at a relatively small incident angle, the incident light transmitted through the transmission region 41-3 in the mask 31 is incident on the imaging element 32.

Furthermore, as illustrated in the lower part of FIG. 5, the incident light incident obliquely from the upper right to the lower left at a relatively small incident angle is modulated by the mask 31, whereby a point spread function (PSF) is formed at a position closer to the center position of the imaging element 32 as illustrated in the range Z12 as compared with the upper part of FIG. 5.

As described above, when the incident angle of the incident light changes, the position of the point spread function (PSF) formed by being modulated by the mask 31 changes (offsets) with respect to the imaging element 32 according to the incident angle. Furthermore, the wider the allowable range of the incident angle to be the imaging range, the larger the size of the mask 31 needs to be configured with respect to the imaging element 32.

It similarly applies to a case where the transmission region 41 is formed by a condensing element such as a Fresnel zone plate (FZP).

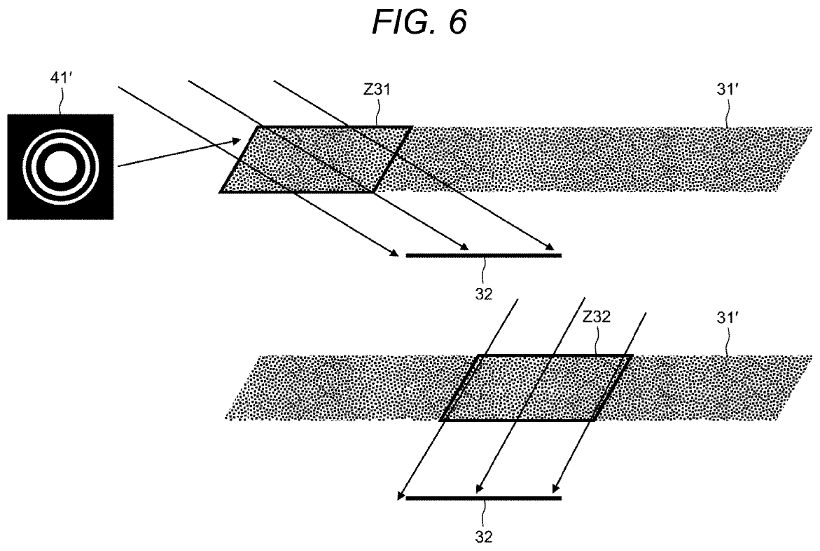

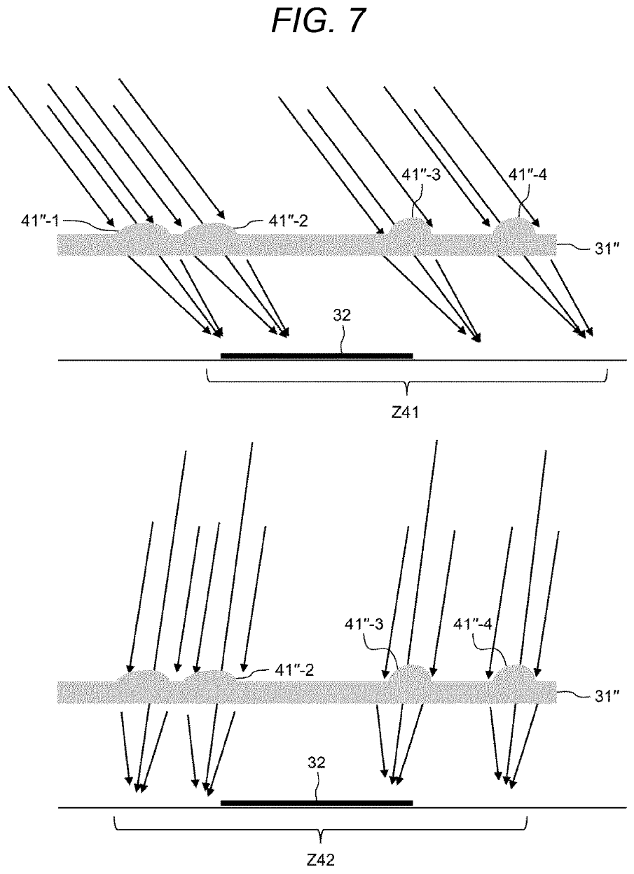

That is, for example, in a case where incident light of a relatively large incident angle is incident on the mask 31′ including the transmission region 41′ in which the condensing element constituted by FZP is formed instead of the transmission region 41 in the mask 31 of FIG. 4 in an oblique direction from the upper left to the lower right in the drawing as illustrated in the upper part of FIG. 6, only the modulated light modulated in a range Z31 near the left end portion of the mask 31′ in the drawing is incident on the imaging element 32 and captured as a modulated image as illustrated in FIG. 6.

On the other hand, as illustrated in the lower part of FIG. 6, in the incident light incident obliquely from the upper left to the lower right in the drawing at a relatively small incident angle, only the modulated light is incident on the imaging element 32 in the range Z32 in the right portion close to the center of the mask 31 and captured as a modulated image.

Furthermore, the point spread function (PSF) generated by the incident light passing through the entire mask 31 has a relationship as illustrated in FIG. 7.

Here, in the case of the mask 31″ in which the condensing element such as the FZP or the lens is formed in the transmission region 41″, as illustrated in FIG. 7, the incident light transmitted through the transmission region 41″ is condensed at a position where the incident light serving as the optical axis transmitted through the center position of the transmission region 41″ is incident on the surface on which the imaging element 32 is formed.

Thereby, for example, as illustrated in the upper part of FIG. 7, in a case where the transmission regions 41″-1 to 41″-4 are formed in the mask 31″, incident light incident at a relatively large incident angle in an oblique direction from the upper left to the lower right is modulated by being transmitted through the entire mask 31″, and a point spread function (PSF) is formed in a range Z41 on the surface on which the imaging element 32 is formed.

Here, in the upper part of FIG. 7, among the incident light incident obliquely from the upper left to the lower right at a relatively large incident angle, only the incident light transmitted through the transmission regions 41″-1 and 41′-2 in the mask 31 is incident on the imaging element 32.

Furthermore, as indicated by the range Z41 in the upper part of FIG. 7, the incident light incident at a relatively large incident angle in an oblique direction from the upper left to the lower right is modulated by the mask 31″, whereby a point spread function (PSF) is formed at a position offset in the right direction with respect to the position of the imaging element 32 as indicated by the range Z41.

On the other hand, as illustrated in the lower part of FIG. 7, the incident light incident obliquely from the upper right toward the lower left in the drawing at a relatively small incident angle is modulated by being transmitted through the entire mask 31″, and a point spread function (PSF) is formed in the range Z42 on the surface on which the imaging element 32 is formed.

The lower part of FIG. 7 illustrates that, among the incident light incident obliquely from the upper right to the lower left at a relatively small incident angle, the incident light transmitted through the transmission region 41″-3 in the mask 31″ is incident on the imaging element 32.

Furthermore, as indicated by a range Z42 in the lower part of FIG. 7, the incident light incident obliquely from the upper right to the lower left at a relatively small incident angle is modulated by the mask 31″, whereby a point spread function (PSF) is formed at a position closer to the center position of the imaging element 32 as compared with the upper part of FIG. 7, as indicated by a range Z42.

As described above, even in the mask 31′ or 31″ in which the condensing element such as the lens or the FZP is formed in the transmission region 41, the position of the point spread function (PSF) formed by being modulated by the masks 31′ and 31″ with respect to the incident light from various incident directions changes (offset from the center position) with respect to the imaging element 32. Furthermore, as the allowable range of the incident angle to be the imaging range is widened, the size of the masks 31′ and 31″ needs to be larger than that of the imaging element 32.

Note that, in FIG. 5, since the transmission region is constituted by FZP, the transmission region is expressed as a transmission region 41′, and in FIG. 6, since the transmission region is constituted by a lens, the transmission region is expressed as a transmission region 41″ for distinction. However, the FZP and the lens are the same in that they are condensing elements, and the effect on the incident light is similar. Therefore, there is no need to distinguish this point.

An advantage of the lensless camera is that a lens is unnecessary, and thus, miniaturization and weight reduction can be realized by eliminating the lens from the device configuration. However, as described above, in order to widen the allowable range with respect to the incident angle (in order to maintain an angle of view similar to the case of using the lens), it is necessary to increase the sizes of the masks 31, 31′, and 31″ with respect to the size of the imaging element, and in this respect, the advantage of the lensless camera is impaired.

Therefore, the mask of the imaging device of the present disclosure realizes a mask having a size smaller than that of the conventional mask 31 while keeping a point spread function (PSF) formed when incident light of various incident angles is modulated into modulated light the same as that of the conventional mask 31, and realizes downsizing of the device configuration.

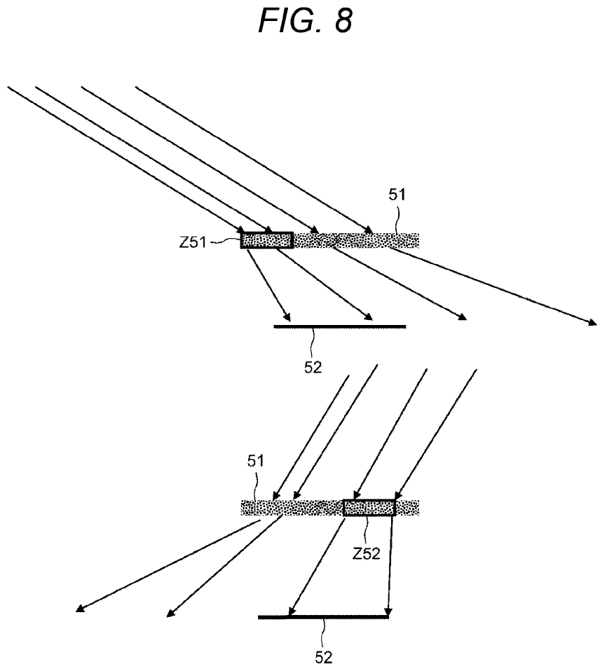

More specifically, for example, as in a mask 51 illustrated in FIG. 8, the mask of the present disclosure changes the direction to become the optical path of the incident light so as to have the same point spread function (PSF) as that of the conventional mask 31, so that the point spread function (PSF) formed when passing through the mask 51 is made the same as that in the mask 31, and the size is made smaller than that of the mask 31.

That is, as illustrated in the upper part of FIG. 8, the direction of the optical path is changed such that the point spread function (PSF) formed in the upper part of FIG. 5 is the same as that in the mask 31 for the incident light of a relatively large incident angle in an oblique direction from the upper left to the lower right in the drawing, and the light transmitted through the surface on which the imaging element 52 is formed spreads with respect to the size of the mask 51.

Note that, in the upper part of FIG. 8, only the incident light transmitted through a range Z51 near the left end portion of the mask 51 in the drawing is modulated and imaged in the imaging element 52 as a modulated image.

Furthermore, similarly, as illustrated in the lower part of FIG. 8, the direction of the optical path is changed such that the point spread function (PSF) formed in the lower part of FIG. 5 is the same as that in the mask 31 even for the incident light of a relatively small incident angle in an oblique direction from the upper left to the lower right in the drawing, and the light transmitted through the surface on which the imaging element 52 is formed spreads with respect to the size of the mask 51.

Note that, in the lower part of FIG. 8, only the incident light transmitted through a range Z52 on the right side relatively close to the center of the mask 51 is modulated and imaged in the imaging element 52 as a modulated image.

As a result, since the size can be reduced while the mask 51 functions similarly to the conventional mask 31, it is possible to downsize the device configuration of the imaging device 11 that functions as a lensless camera without deteriorating the image quality to be imaged.

### 2. Preferred Embodiment

### Configuration Example of Imaging Device of Present Disclosure

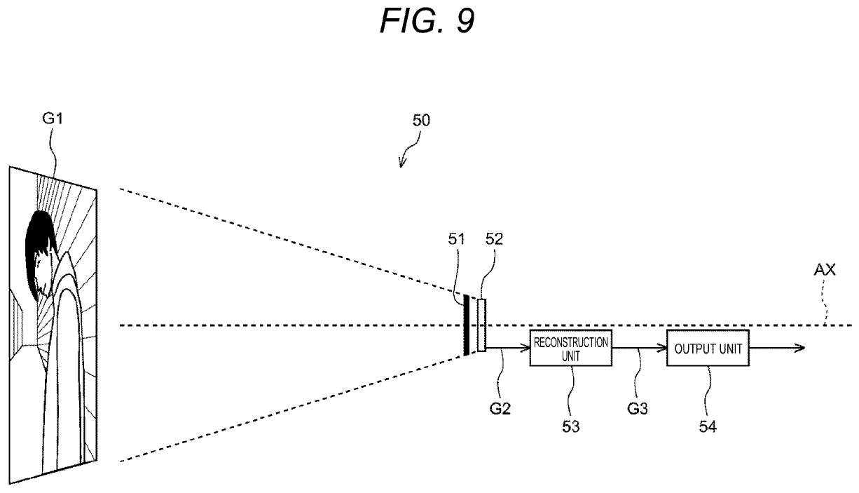

Next, a configuration example of the imaging device of the present disclosure will be described with reference to FIG. 9. An imaging device 50 in FIG. 9 includes a mask 51, an imaging element 52, a reconstruction unit 53, and an output unit 54.

Note that the imaging element 52, the reconstruction unit 53, and the output unit 54 are basically configured to have the same functions as the imaging element 32, the reconstruction unit 33, and the output unit 34 in FIG. 1, and thus description thereof is omitted.

That is, the imaging device 50 in FIG. 9 is different from the imaging device 11 in FIG. 1 in that a mask 51 is provided instead of the mask 31.

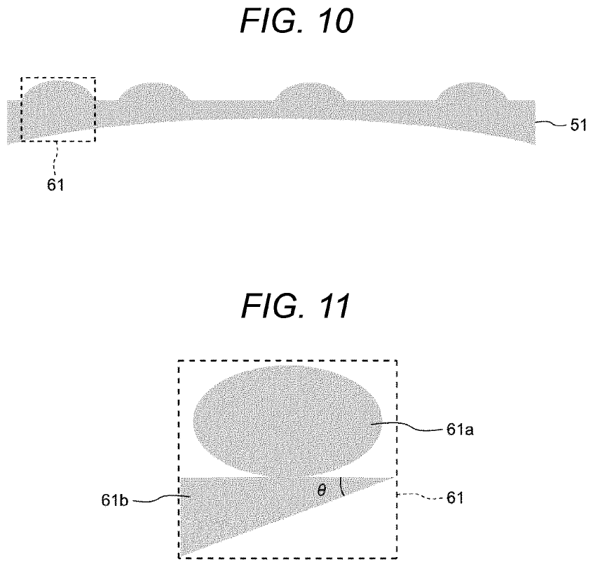

The mask 51 has a configuration as illustrated in FIG. 10, and has a configuration in which an optical path light condensing changing unit 61 is provided corresponding to the transmission region 41 in the conventional mask 31. As illustrated in FIG. 8, the optical path light condensing changing unit 61 changes the optical path of the incident light so as to realize a point spread function (PSF) similar to that of the conventional mask 31. As a result, the size of the mask 31 is reduced while a point spread function (PSF) similar to that of the conventional mask 51 is realized.

The optical path light condensing changing unit 61 has an optical path changing function of changing the optical path of the light condensed by transmitting the condensing element in a direction in which a point spread function (PSF) similar to that of the mask 31 of the related art is realized in addition to the conventional condensing function of the transmission region 41″ in the case of using the condensing element in the transmission region 41.

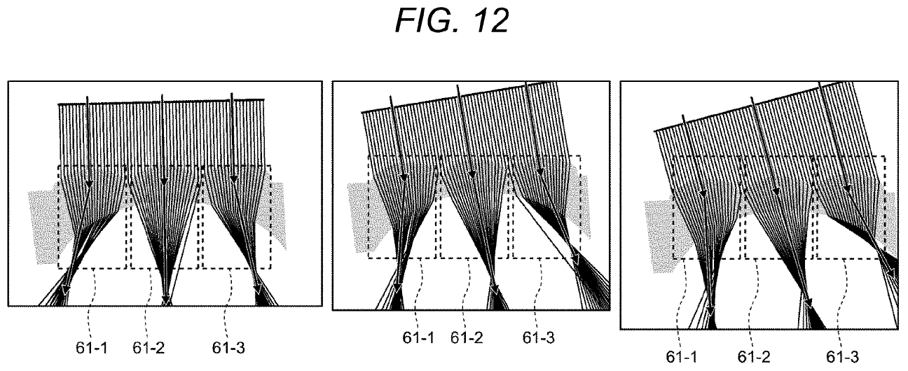

The optical path light condensing changing unit 61 can be realized by, for example, a configuration in which a lens 61a and a prism 61b are combined as illustrated in FIG. 11.

That is, the lens 61a constituting the optical path light condensing changing unit 61 condenses the incident light, and the prism 61b changes the optical path of the condensed incident light in a direction in which a point spread function (PSF) similar to that of the conventional mask 31 is realized.

In the lens 61a and the prism 61b, the changing direction of the optical path is adjusted by adjusting the focal length of the lens 61a and the angle θ of the end portion of the prism 61b according to the position of each optical path light condensing changing unit 61 in the mask 51 and the direction of the optical path for realizing the point spread function (PSF) similar to the conventional mask 31.

In the mask 51 of FIG. 10, a curved convex portion corresponding to the lens 61a is formed on the upper surface at the portion where the optical path light condensing changing unit 61 is configured, and a prism according to the distance from the center position of the mask 51 and the changing direction of the optical path is continuously formed on the lower surface, so that the curved surface structure is convex upward as a whole.

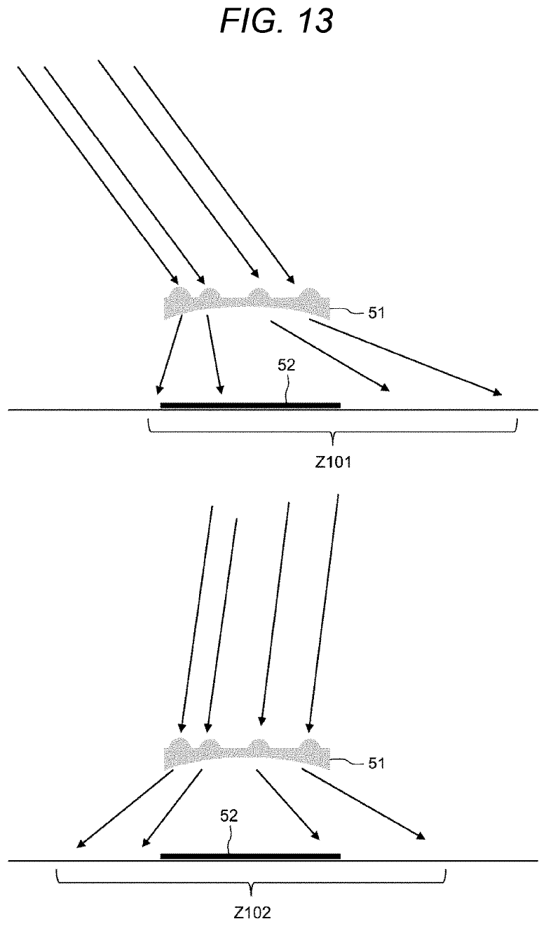

FIG. 12 is a simulation of a change in the optical path when incident light is incident at various incident angles from the upper side to the lower side in the drawing in a case where the three optical path light condensing changing units 61-1 to 61-3 are formed in a one-dimensional direction.

In the drawing, one black line indicates one optical path, an arrow indicates a direction of the optical path on the optical axis, and a simulation result when the incident angle of the incident light is changed in two stages from left to right in FIG. 12 is illustrated.

As illustrated in FIG. 12, each of the optical path light condensing changing units 61-1 to 61-3 condenses the incident light according to the incident angle, and changes the direction of the optical path to apply modulation and transmit the modulated light.

With such a configuration, for example, as illustrated in the upper part of FIG. 13, the mask 51 condenses and changes the optical path of incident light having a relatively large incident angle obliquely incident from the upper left to the lower right, and then, modulates the incident light to form the same point spread function as the point spread function realized in the range Z41 of FIG. 7 in a range Z101 on the surface on which the imaging element 52 is provided.

Furthermore, for example, as illustrated in the lower part of FIG. 13, the mask 51 forms the same point spread function as the point spread function realized in the range Z42 of FIG. 7 in a range Z102 on the surface provided with the imaging element 52 by condensing and changing the optical path of incident light having a relatively small incident angle incident obliquely from the upper right toward the lower left and then performing modulation.

The optical path light condensing changing unit 61 may have a configuration other than the configuration in FIG. 11 as long as it is configured to condense the incident light, change the optical path according to the incident angle so as to realize the point spread function (PSF) realized in the conventional mask 31, and apply modulation.

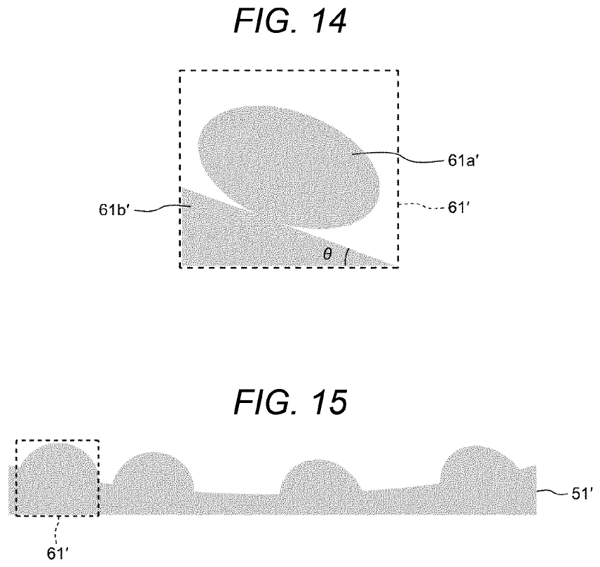

For example, instead of the optical path light condensing changing unit 61, an optical path light condensing changing unit 61′ as illustrated in FIG. 14 may be provided. The optical path light condensing changing unit 61′ includes a lens 61a′ and a prism 61b′.

In FIG. 11, the oblique side portion of the prism 61b is formed on the back surface side with respect to the light incident direction, but in the prism 61b′ of FIG. 14, the oblique side portion is formed on the opposite side with respect to the light incident direction, and the lens 61a′ is inclined according to the angle θ at which the oblique side portion is inclined.

The optical path light condensing changing unit 61′ in FIG. 14 forms a mask 51′ as illustrated in FIG. 15, for example.

Since the mask 51′ in FIG. 15 includes the optical path light condensing changing unit 61′, the configuration corresponding to the oblique side portion of the prism 61b′ is directed upward in the drawing. Therefore, a convex portion is formed such that a convex curved surface is formed downward on the upper surface side as a whole and the lens 61a′ is arranged according to the inclination of the curved surface.

### Specific Simulation Example

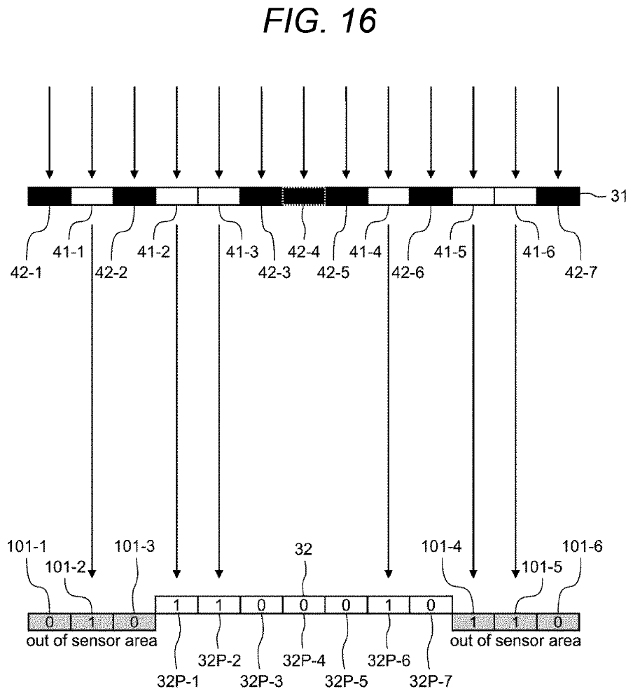

Next, with reference to FIGS. 16 to 19, a specific simulation example when a point spread function (PSF) realized by the conventional mask 31 transmitting the incident light is realized by a mask 51′ having a smaller size than the mask 31 will be described.

Note that, as illustrated in FIG. 16, the conventional mask 31 has a one-dimensional configuration in which the transmission region 41 and the light shielding region 42 are set on the basis of a basic sequence [0, 1, 0, 1, 1, 0, 0] including a uniformly redundant array (URA) pattern having a length of 7 as a binary redundant array.

That is, in FIG. 16, the light shielding region 42 is arranged at a position corresponding to 0 so as to correspond to the basic sequence [0, 1, 0, 1, 1, 0, 0], and the transmission region 41 is arranged at a position corresponding to 1. Note that, in this example, it is assumed that the transmittance of the transmission region 41 is 100%, and the transmittance of the light shielding region 42 is 0%. With such a configuration, a light shielding region 42-1, a transmission region 41-1, a light shielding region 42-2, a transmission region 41-2, a transmission region 41-3, and a light shielding region 42-4 are arranged in this order from the left in the drawing so as to correspond to the basic sequence [0, 1, 0, 1, 1, 0, 0]. On the right side of the light shielding region 42-4, a light shielding region 42-5, a transmission region 41-4, a light shielding region 42-6, a transmission region 41-5, a transmission region 41-6, and a light shielding region 42-7 are arranged in this order in a similar pattern.

That is, in FIG. 15, a mask 31 in which six transmission regions 41 and seven light shielding regions 42 are arranged according to a basic sequence including a uniformly redundant array (URA) pattern having a length of 7 as a binary redundant array is formed. Note that the transmission region 41 and the light shielding region 42 are each configured with a unit length of 1. That is, the length of the mask 31 in FIG. 16 is the unit length 13.

The imaging element 32 formed on the back surface side with respect to the incident direction of the incident light of the mask 31 is arranged with a position corresponding to the center position of the mask 31 as the center, has a unit length of 7, and each range of the unit length 1 is a light receiving region 32P-1 to 32-7.

Furthermore, the range of the left and right unit lengths 3 of the imaging element 32 is assumed to be a non-light receiving region (out of sensor area) of the imaging element 32.

Here, in a case where the incident light is incident from vertically above in the drawing, when the amount of light transmitted through the transmission region 41 having a unit length of 1 is expressed by one arrow with the amount of light transmitted through the transmission region 41 being 1, light of the amount of light 1 is received in each of the region 101-2, the light receiving regions 32P-1, 32P-2, and 32P-6, and the regions 101-4 and 101-5.

At this time, for each of the regions 101-1 to 101-3, the light receiving regions 32P-1 to 32P-7, and the regions 101-4 to 101-6, when a region in which the amount of received light is 1 and a region in which there is no incident light received and the amount of received light is 0 are expressed as a light receiving pattern from the left side in the drawing, [0, 1, 0, 1, 1, 0, 0, 0, 1, 0, 1, 1, 0] is obtained, and a pattern corresponding to the basic sequence including the above-described URA pattern with the length of 7 is obtained.

The light receiving pattern of the incident light on the surface on the side where the imaging element 32 is provided is information corresponding to a point spread function (PSF) when the mask 31 transmits the incident light.

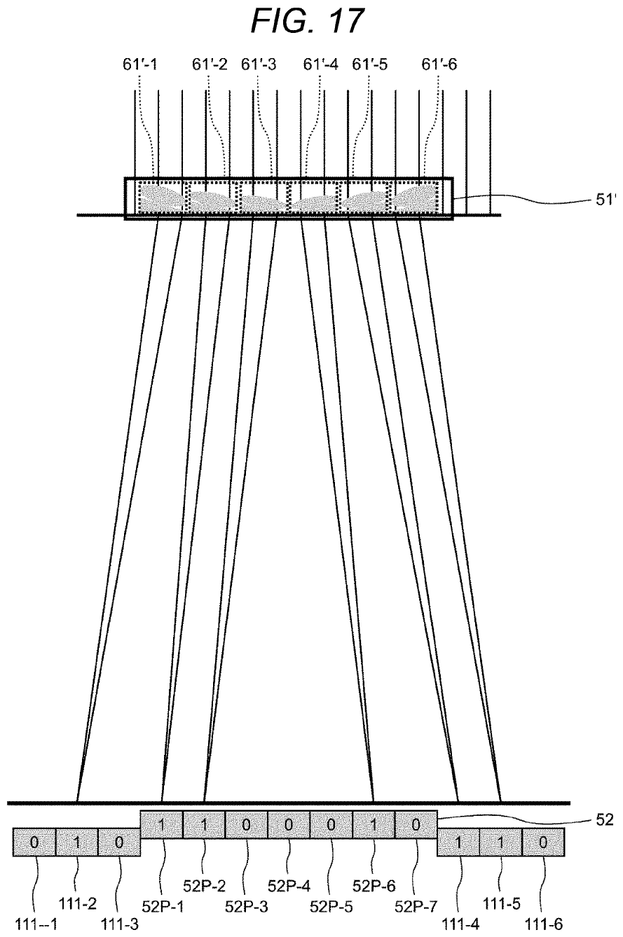

FIG. 17 is a configuration example of the mask 51′ in which incident light is condensed without changing a point spread function (PSF) realized by the mask 31 in FIG. 16 to change an optical path.

The mask 51′ has a configuration in which the configuration corresponding to the transmission regions 41-1 to 41-6 in the conventional mask 31 is replaced with the optical path light condensing changing units 61′-1 to 61′-6.

The optical path light condensing changing units 61′-1 to 61′-6 condense the incident light incident on themselves, and change the optical paths toward positions where the incident light transmitted through the transmission regions 41-1 to 41-6 in the mask 31 is received.

Here, as illustrated in FIG. 17, for the same imaging element 52 as the imaging element 32, light receiving regions 52P-1 to 52P-7 are defined, and non-light receiving regions are defined as regions 111-1 to 11-3 in order from the left on the left side of the imaging element 32, and similarly, regions 111-4 to 111-6 in order from the left on the right side of the imaging element 32.

At this time, for each of the regions 111-1 to 111-3, the light receiving regions 52P-1 to 52P-7, and the regions 111-4 to 111-6, when a region in which the amount of received light is 1 and a region in which there is no received incident light and the amount of received light is 0 are expressed as a light receiving pattern from the left side in the drawing, [0, 1, 0, 1, 1, 0, 0, 0, 1, 0, 1, 1, 0] is obtained, and it is expressed that the point spread function (PSF) of the mask 51′ matches the point spread function (PSF) of the conventional mask 31 illustrated in FIG. 15.

Furthermore, since the mask 51′ can be theoretically constituted only by the optical path light condensing changing unit 61′ corresponding to the transmission region 41 in the conventional mask 31, as illustrated in FIG. 17, in the case of the mask 51′, the length thereof can be a unit length 6, and can be made approximately half the unit length 13, which is the length of the mask 31.

In other words, since the mask 51′ has a prism structure such as the prism 61b′ disposed below the lens 61a′ serving as the condensing element to change the direction serving as the main axis of the optical path, the size of the mask can be made smaller than that of the mask 31.

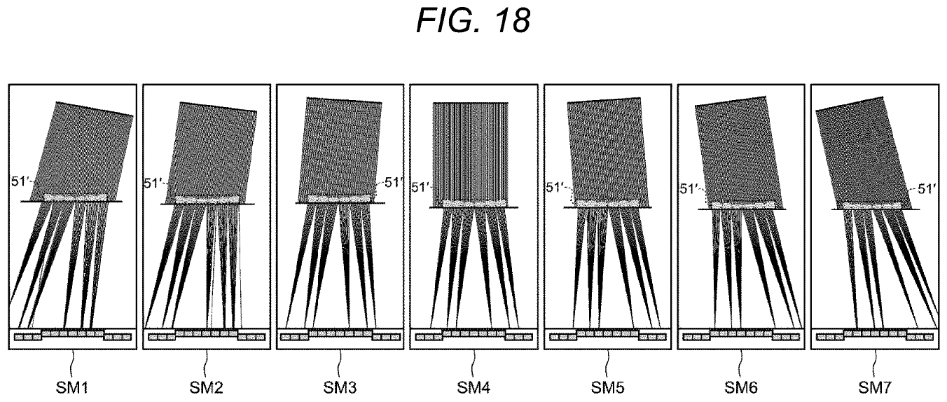

FIG. 18 illustrates a simulation example when incident light is incident on the mask 51′ while changing the incident angle. In FIG. 18, the simulations SM1 to SM7 of seven incident angles are illustrated, and the simulation SM4 serving as the center position in the drawing is a simulation example when incident light having an incident angle of 0 is incident. In addition, with the simulation SM4 as a reference, a simulation result when the incident angle of the incident light descending leftward is increased stepwise toward the left direction in the drawing, that is, in the order of the simulations SM3, SM2, and SM1 is illustrated. Similarly, there is illustrated a simulation result when the incident angle of the right-downward incident light is increased stepwise toward the right direction with reference to the simulation SM4 in the drawing, that is, in the order of the simulations SM5, SM6, and SM7.

In FIG. 18, the light receiving patterns corresponding to the respective point spread functions of the simulations SM1 to SM7 are, in order from the left, [1, 1, 0, 0, 0, 1, 0, 1, 1, 0, 0, 0, 0], [0, 1, 1, 0, 0, 0, 1, 0, 1, 1, 0, 0, 0], [1, 0, 1, 1, 0, 0, 0, 1, 0, 1, 1, 0, 0,], [0, 1, 0, 1, 1, 0, 0, 0, 1, 0, 1, 1, 0], [0, 0, 1, 0, 1, 1, 0, 0, 0, 1, 0, 1, 1], [0, 0, 0, 1, 0, 1, 1, 0, 0, 0, 1, 0, 1], [0, 0, 0, 0, 1, 0, 1, 1, 0, 0, 0, 1, 0].

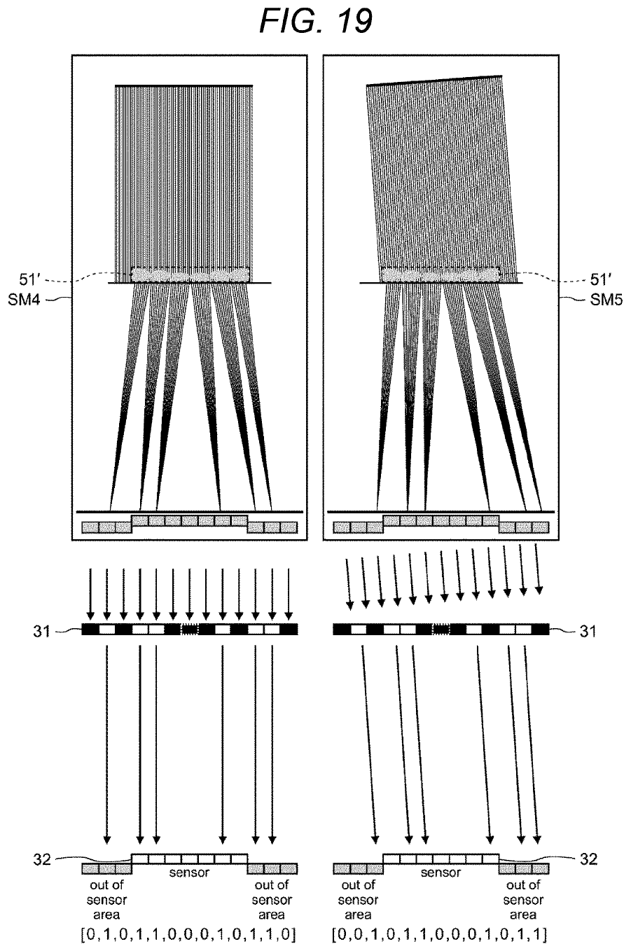

FIG. 19 is a comparison of the light receiving patterns of the simulations SM4 and SM5 among the simulations M1 to SM7 of FIG. 18 when the corresponding mask 31 is used.

More specifically, the upper part of FIG. 19 illustrates the simulations SM4 and SM5 among the simulations SM1 to SM7 of FIG. 18 from the left, and the lower part of FIG. 19 illustrates an example of a light receiving pattern corresponding to a point spread function formed by using the conventional mask 31 when incident light having an incident angle corresponding to the simulations SM4 and SM5 is incident from the left.

As illustrated in FIG. 19, the mask 51′ realizes a light receiving pattern corresponding to the same point spread function (PSF) as that of the mask 31 for the incident light at any incident angle.

That is, it is illustrated that the mask 51′ of the present disclosure can be approximately half the size of the conventional mask 31 while still realizing a point spread function (PSF) with the conventional mask 31. Note that, although not illustrated, the same point spread function (PSF) as the conventional mask 31 is realized in any of the simulations SM1 to SM7 in FIG. 18.

By adopting such masks 51′ and 51, the mask size can be made smaller than that of the conventional mask 31 without deteriorating the image quality of the original image to be reconstructed. As a result, since the sizes of the masks 51 and 51′ are reduced, the device configuration itself of the imaging device 50 can be downsized.

Note that, in the above description, an example has been described in which the pattern of the masks 51 and 51′ is a pattern corresponding to the binary code (an example in which the transmittance of the incident light collected and changed in the optical path is 100%); however, a pattern corresponding to a non-binary code may be used. In this case, the optical path light condensing changing units 61 and 61′ condenses the incident light, changes the direction of the optical path, further changes the transmittance, and performs modulation.

Similarly, the conventional mask 31 to be a reference of the point spread function (PSF) realized by the masks 51 and 51′ may also be realized by a pattern including not only binary codes but also non-binary codes.

Furthermore, the transmission region 41 of the conventional mask 31, which serves as a reference of the point spread function (PSF) realized by the masks 51 and 51′, may be realized not only by a simple opening but also by a lens (refractive lens) realized using a refractive index of a medium to be a material such as glass, a diffractive optical condensing element such as FZP, a meta-surface lens, or the like.

Therefore, also in the mask 51 for realizing the same point spread function as the point spread function (PSF) realized by the conventional mask 31 serving as the reference, the optical path light condensing changing unit 61 may be realized by combining the prism with the refractive lens, the diffractive optical condensing element, the meta-surface lens, and the like.

Furthermore, in the above, an example of a case where a point spread function (PSF) based on a uniformly redundant array (URA) pattern is used has been described as a simulation example, but other patterns may be used, and for example, a modified URA (MURA) pattern may be used.

Furthermore, in the above description, an example has been described in which the optical path light condensing changing units 61 and 61′ of the masks 51 and 51′ are configured by the lens 61a and the prism 61b or the lens 61a′ and the prism 61b′, respectively. However, as described above, as long as the incident light can be condensed so that the point spread function realized by the conventional mask 31 can be realized and the optical path can be changed, the mask may be configured from other shapes.

### 3. Application Example

In the above, an example has been described in which, instead of the transmission region 41, the optical path light condensing changing units 61, 61′, and 61″ that collect incident light without changing the point spread function in the conventional mask 31 and change the optical path are provided, and the light shielding region 42 is eliminated to realize the masks 51, 51′, and 51″ having a size smaller than that of the mask 31.

However, a small distance measurement sensor may be realized by applying a similar technology.

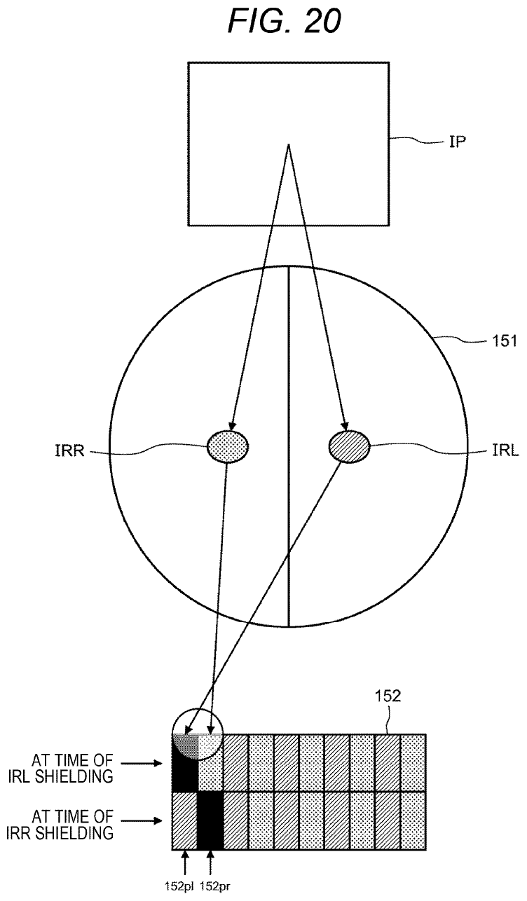

For example, in a depth measurement device in a distance measurement sensor including a ZAF pixel or a dual pixel sensor, as illustrated in FIG. 20, the pupil of the lens 151 is divided into left and right pupils IRR and IRL, and light passing through the pupils is configured to be incident on different pixels.

That is, as illustrated in FIG. 20, the incident light from the subject IP is incident on the different pixels 152pl and 152pr on the imaging element 152 while shielding one of the left and right pupils IRR and IRL in the lens 151.

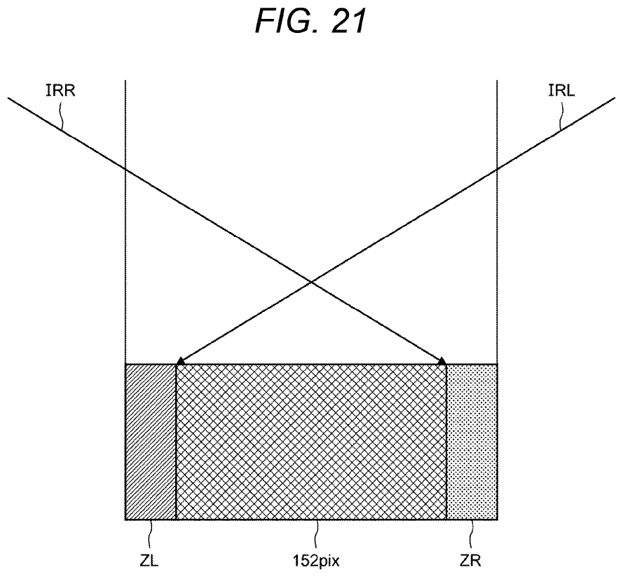

For example, in FIG. 20, the incident light from the subject IP that has transmitted through the pupil IRL is incident on the left region ZL in the pixel 152pix illustrated in FIG. 21, and the incident light from the subject IP that has transmitted through the pupil IRR is incident on the right region ZR in the pixel 152pix illustrated in FIG. 21.

Therefore, as illustrated in FIG. 21, when the left pupil IRL is shielded, the incident light transmitted through the pupil IRR enters the right region ZR of the pixel 152pix, whereby an image is captured in the corresponding pixel 152pl in FIG. 20. Similarly, as illustrated in FIG. 21, when the right pupil IRR is shielded, the incident light transmitted through the pupil IRL enters the left region ZL of the pixel 152pix, whereby an image is captured at the corresponding pixel 152pr in FIG. 20.

In this manner, the right and left parallax amounts are obtained by imaging the same target from different viewpoints for each of the pixels 152pl and 152pr, and the depth value is measured from the parallax amount. The parallax amount by the depth value measurement method is a distance between the centroid positions of the right and left pupils IRR and IRL of the lens.

That is, sufficient parallax cannot be obtained unless the lens 151 has a diameter larger than a predetermined size. However, when a lens having a diameter larger than a predetermined size is used in order to obtain sufficient parallax, the lens is increased in size and weight by that amount, and as a result, the imaging device is increased in size and weight.

On the other hand, when the original image is independently reconstructed from the modulated light obtained from the regions at both ends of the mask using the mask of the present disclosure, the image having the parallax amount almost close to the size of the mask can be obtained only by widening the region of the mask to the left and right to secure the parallax amount, and the depth information can be acquired by the thin camera.

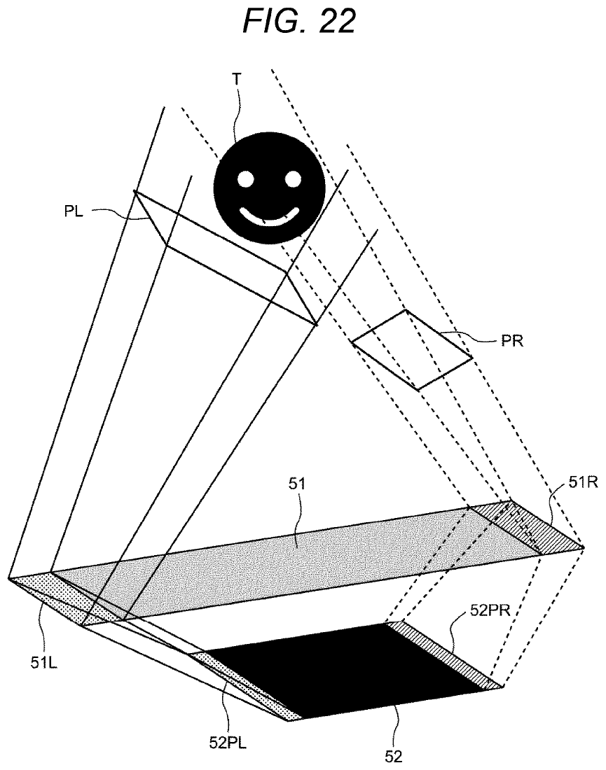

That is, as illustrated in FIG. 22, original images of different viewpoints obtained from the same subject T are referred to as PL and PR, respectively, and are added to the left and right end portions of the mask 51 as mask regions 51R and 51L that transmit the original images, respectively, and modulated light modulated by the mask regions 51R and 51L is captured as modulated images in the regions 52PR and 52PL at the left and right end portions of the imaging element 52. The regions 51R and 51L of the mask 51 are obtained by applying the technology of the present disclosure with respect to the structure itself that bends the optical path, and the optical paths of the original images PL and PR are changed to the regions PR and PL of the left and right end portions in the imaging element 52, respectively.

Furthermore, by independently reconstructing the modulated images in the regions 52PR and 52PL, the original images PL and PR of different viewpoints obtained from the same subject T can be acquired.

Then, it is possible to measure the distance to the subject T by obtaining the parallax amount on the basis of the reconstructed original images PL and PR.

At this time, it is sufficient that the mask regions 51R and 51L are widened such that the distance therebetween for securing the parallax amount is separated by a distance that can be measured.

With such a configuration, the mask 51 is slightly enlarged by the addition of the regions 51R and 51L, but a sufficient parallax amount can be gained even with the small imaging element 52 using a mask smaller than the conventional mask, and it is possible to function as a highly accurate small distance measurement sensor.

Note that, in FIG. 22, an example in which the mask regions 51R and 51L for obtaining parallax images are provided at both ends of the mask 51 has been described. However, multi-eye stereo imaging may be realized by independently reconstructing different parallax images forming a pair also in a plurality of other regions. This makes it possible to acquire depth information with higher accuracy.

Note that the present disclosure can also have the following configurations.
<1> An imaging device including:
a modulation mask that modulates incident light to convert the incident light into modulated light;
an imaging element that captures a modulated image including the modulated light transmitted through the modulation mask; and
a reconstruction unit that reconstructs an image corresponding to the incident light on the basis of the modulated image, in which
the modulation mask condenses the incident light to realize a point spread function same as a reference mask realized by two-dimensionally arranging a transmission region that transmits the incident light and a light shielding region that shields the incident light, and changes and modulates an optical path.
<2> The imaging device according to <1>, in which
the transmission region of the reference mask includes a condensing element.
<3> The imaging device according to <2>, in which
the condensing element is a refraction lens.
<4> The imaging device according to <2>, in which
the condensing element is a diffractive optical condensing element.
<5> The imaging device according to <2>, in which
the condensing element is a meta-surface lens.
<6> The imaging device according to <1>, in which
the modulation mask includes an optical path light condensing changing unit that condenses the incident light and changes the optical path of the condensed incident light to realize the point spread function same as the reference mask.
<7> The imaging device according to <6>, in which
the optical path light condensing changing unit has a configuration corresponding to the transmission region in the reference mask and transmits the incident light.
<8> The imaging device according to <6>, in which
the optical path light condensing changing unit includes:
   a condensing element that condenses the incident light; and
   an optical path changing unit that changes an optical path of the incident light condensed by the condensing element.
<9> The imaging device according to <8>, in which
the condensing element is a refraction lens.
<10> The imaging device according to <8>, in which
the condensing element is a diffractive optical condensing element.
<11> The imaging device according to <8>, in which
the condensing element is a meta-surface lens.
<12> The imaging device according to <8>, in which
the optical path changing unit is a prism.
<13> The imaging device according to any one of <1> to <12>, in which
the reference mask is a binary mask.
<14> The imaging device according to any one of <1> to <12>, in which
the reference mask is a non-binary mask.
<15> The imaging device according to any one of <1> to <14>, in which
the point spread function is based on a uniformly redundant array (URA) pattern or a modified URA (MURA) pattern.

### REFERENCE SIGNS LIST

41 Imaging device
51, 51′, 51″ Mask
61, 61′, 61″ Optical path light condensing changing unit
61a, 61a′ Lens
62a, 62a′ Prism

1. An imaging device comprising:
a modulation mask that modulates incident light to convert the incident light into modulated light;
an imaging element that captures a modulated image including the modulated light transmitted through the modulation mask; and
a reconstruction unit that reconstructs an image corresponding to the incident light on a basis of the modulated image, wherein
the modulation mask condenses the incident light to realize a point spread function same as a reference mask realized by two-dimensionally arranging a transmission region that transmits the incident light and a light shielding region that shields the incident light, and changes and modulates an optical path.

2. The imaging device according to claim 1, wherein
the transmission region of the reference mask includes a condensing element.

3. The imaging device according to claim 2, wherein
the condensing element is a refraction lens.

4. The imaging device according to claim 2, wherein
the condensing element is a diffractive optical condensing element.

5. The imaging device according to claim 2, wherein
the condensing element is a meta-surface lens.

6. The imaging device according to claim 1, wherein
the modulation mask includes an optical path light condensing changing unit that condenses the incident light and changes the optical path of the condensed incident light to realize the point spread function same as the reference mask.

7. The imaging device according to claim 6, wherein
the optical path light condensing changing unit has a configuration corresponding to the transmission region in the reference mask and transmits the incident light.

8. The imaging device according to claim 6, wherein
the optical path light condensing changing unit includes:
a condensing element that condenses the incident light; and
an optical path changing unit that changes an optical path of the incident light condensed by the condensing element.

9. The imaging device according to claim 8, wherein
the condensing element is a refraction lens.

10. The imaging device according to claim 8, wherein
the condensing element is a diffractive optical condensing element.

11. The imaging device according to claim 8, wherein
the condensing element is a meta-surface lens.

12. The imaging device according to claim 8, wherein
the optical path changing unit is a prism.

13. The imaging device according to claim 1, wherein
the reference mask is a binary mask.

14. The imaging device according to claim 1, wherein
the reference mask is a non-binary mask.

15. The imaging device according to claim 1, wherein
the point spread function is based on a uniformly redundant array (URA) pattern or a modified URA (MURA) pattern.
